(19) United States
(12) Patent Application Publication
(10) Pub. No.: US 2026/0249114 A1
(43) Pub. Date: Aug. 27, 2026

(54) GAS HYDRATE FIRE EXTINGUISHING GRENADE, AND METHOD FOR EXTINGUISHING FLAMES BY USING SAME

(71) Applicant: KOREA INSTITUTE OF INDUSTRIAL TECHNOLOGY, Cheonan-si (KR)

(72) Inventors: Ju Dong LEE, Busan (KR); Chang Su JEON, Busan (KR); Dae Geun NAM, Seoul (KR)

(21) Appl. No.: 18/876,862

(22) PCT Filed: Oct. 27, 2022
(86) PCT No.: PCT/KR2022/016594

§ 371 Date: Dec. 19, 2024

(30) Foreign Application Priority Data
Jun. 30, 2022 (KR) 10-2022-0080139

(51) Int. Cl. A62C 3/02

(52) U.S. Cl. CPC A62C 3/025

(57) ABSTRACT

The present invention relates to a gas hydrate fire extinguishing grenade and a method of extinguishing flames by using the same, wherein the grenade includes a main body; a gas hydrate member filled in the main body; a detection member provided on the outer side of the main body; an expansion agent provided in the central part of the main body; and a transmission member for transmitting, to the expansion agent, an impact sensitivity or temperature state, which is detected by the detection member, and thus the present invention has advantages such as an oxygen blocking function, a cooling action, flame chain reaction inhibition, a wide fire suppression range, a physical property of quickly absorbing heat from the surroundings, and a remote throwing function, thereby being applicable to various fires.

### TECHNICAL FIELD

The present invention relates to a gas hydrate fire extinguishing grenade and a method of extinguishing flames using the same, and more particularly, to a gas hydrate fire extinguishing grenade which is composed only of water and fire extinguishing gas, minimizes environmental damage, and has higher fire penetration performance than other fire extinguishing agents, enabling effective fire suppression through remote throwing, etc., and a method of extinguishing flames using the same.

### Background Art

Typically, when a fire occurs, firefighting equipment in a building extinguishes the fire by spraying water or chemicals at the location of the fire using a foam fire extinguishing system, a Halon fire extinguishing system, and a water spraying system such as sprinklers according to the fire alarm from automatic detectors or manual fire alarms.

The foam fire extinguishing system is used for fires involving flammable liquids where water-based fire extinguishing methods are less effective or there is a risk of the fire spreading. The foam fire extinguishing system suffocates a fire by covering the surface of the combustion product with a blanket of fine bubbles, which are formed when an aqueous solution in which water and a foam fire extinguishing agent are mixed in a certain ratio is foamed by air, and cutting off the air supply.

The Halon fire extinguishing system extinguishes a fire by suppressing the combustion reaction of the fire using a halogenated fire extinguishing agent. The halogenated fire extinguishing agent refers to a mixture of halogen elements F, Cl, and Br with aliphatic saturated hydrocarbons. The halogenated fire extinguishing agent is good at inhibiting the chain reaction of combustion.

The sprinkler is an automatic fire extinguishing system where the fuse in the head is automatically blown in response to a fire, causing water to spray out in the form of a shower from each deflector to extinguish the fire and simultaneously notifying its occurrence. This system is composed of a sprinkler head that releases water like rain, a pipe that supplies water, an alarm device, a pump, and a water source.

However, despite the high construction and installation costs of these fire extinguishing systems, they are poor at suppressing fires in peripheral areas in a building, and thus there are blind spots for fire extinguishing in the building.

Recently, due to climate change and other causes, large-scale forest fires and fires at industrial sites that are difficult to access frequently occur, emerging as an international disaster. In the case of forest fires, it is difficult to extinguish fires at night or through remote throwing, and for high-rise building fires, it is also difficult to extinguish fires that occur on the 15th floor or higher due to the performance limitations of pumps. Therefore, there is a need to develop a fire extinguishing agent or system with excellent performance compared to existing fire extinguishing systems.

Examples of fire extinguishing technologies addressing this need are disclosed in the following Patent Documents 1 to 3.

For example, Patent Document 1 (Korean Registered Patent No. 10-1034564 registered on May 4, 2011) discloses an automatic fire extinguishing device including a storage portion containing gas hydrate and a nozzle portion that is connected to the storage portion and sprays the gas dissociated from the gas hydrate stored in the storage portion at the location of a fire, wherein the gas hydrate includes a solvent and gas, and the gas is a variety of gases selected from the group consisting of carbon dioxide, SF₆ gas, HFC series gases, and Halon series gases.

Patent Document 2 (Korean Unexamined Patent Publication No. 2022-0085974 published on Jun. 23, 2022) discloses a fire extinguishing bomb including a fire extinguishing agent case that is conventionally formed and provides an internal space for a powder fire extinguishing agent, the case includes an upper body, which is open at the lower part to communicate with the internal space, and an air injection base for sealing the open lower part of the upper body; and a compressed air dispersion means that is provided in the fire extinguishing agent case and broken by an external impact and releases compressed air to disperse the powder fire extinguishing agent when broken by impact, wherein the fire extinguishing agent case is formed using a mixture of ammonium phosphate ((NH₄)₃PO₄) and starch.

Patent Document 3 (Korean Registered Patent No. 10-2112321 registered on May 12, 2020) discloses a fire extinguishing bomb for large-scale forest fires filled with a powder fire extinguishing agent to extinguish a forest fire by being thrown from an aerial vehicle, the bomb includes a forest fire extinguishing container body with an internal space; a powder fire extinguishing agent and a dehumidifier to remove moisture, which are filled in the internal space of the forest fire extinguishing container body; a compressed air dispersion means to disperse the powder fire extinguishing agent filled in the forest fire extinguishing container body by the charged compressed air; and an aerial explosion means that explodes in the air after being dropped from the aerial vehicle and disperses the filled powder fire extinguishing agent in the air.

### DISCLOSURE

### Technical Problem

As described above, Patent Document 1 discloses a function where clean fire extinguishing agents in a gaseous state, such as carbon dioxide, HFC series, or Halon series, are combined with water molecules or polar solvents, stored stably in a gas hydrate form, and then automatically released as gas to extinguish a fire when it occurs. However, this method had the problem of not being applicable to fire sites that are difficult to access such as high-rise buildings, forest fires, and industrial sites.

In addition, Patent Document 2 discloses a fire extinguishing agent case that can be used as fertilizer for the soil after being thrown or dropped at fire sites, and Patent Document 3 discloses a configuration of a fire extinguishing bomb filled with a powder fire extinguishing agent to extinguish forest fires by dropping the agent from an aerial vehicle, wherein the forest fire extinguishing container body is composed of eco-friendly materials to prevent environmental pollution. However, these technologies had the problem of reduced fire extinguishing effectiveness because they could not perform oxygen blocking and cooling and inhibit chain reactions.

To solve the above-described problems, one object of the present invention is to provide a gas hydrate fire extinguishing grenade that can be applied to extinguishing various difficult-to-access fires, including high-rise building fires and forest fires, by generating a large amount of fire extinguishing gas and releasing water when a fire occurs, and a method of extinguishing flames using the same.

Another object of the present invention is to provide a gas hydrate fire extinguishing grenade that can be provided in the form of a bomb by filling the gas hydrate with a fire extinguishing gas, and a method of extinguishing flames using the same.

Still another object of the present invention is to provide a gas hydrate fire extinguishing grenade that can be used as a fire delay strategy or protection strategy through remote throwing, and a method of extinguishing flames using the same.

### Technical Solution

In order to achieve the above objects, the gas hydrate fire extinguishing grenade for extinguishing flames and preventing the spread of fire according to the present invention includes a main body, a gas hydrate member filled in the main body, a detection member provided on the outer side of the main body, an expansion agent provided in the central part of the main body, and a transmission member that transmits the impact sensitivity or the temperature detected from the detection member to the expansion agent.

The gas hydrate fire extinguishing grenade according to the present invention further includes a hydrate breaker provided to surround the expansion agent.

In the gas hydrate fire extinguishing grenade according to the present invention, the main body is composed of non-flammable plastic, and the expansion agent includes sodium azide or guanidine nitrate.

In the gas hydrate fire extinguishing grenade according to the present invention, the gas hydrate member is provided in the form of powder or pellets.

In the gas hydrate fire extinguishing grenade according to the present invention, the fire extinguishing gas of the gas hydrate member is composed of any one of CO₂, HFC-125, HFC-23, and FIC-1311 or a mixture thereof.

In the gas hydrate fire extinguishing grenade according to the present invention, an igniter that operates the expansion agent is further included, the transmission member is composed of an ignition wire, and the ignition wire is connected between the igniter and the expansion agent.

In the gas hydrate fire extinguishing grenade according to the present invention, the detection member is an impact sensor that detects impact sensitivity during free fall, and the igniter is a piezoelectric element that operates according to the impact sensitivity detected by the impact sensor.

In the gas hydrate fire extinguishing grenade according to the present invention, a weight member composed of a different material from the main body is provided at the lower central part of the main body, and the impact sensor and the piezoelectric element are provided at the weight member.

In the gas hydrate fire extinguishing grenade according to the present invention, the piezoelectric element is ignited when free falling from an altitude of 10 m or more.

In the gas hydrate fire extinguishing grenade according to the present invention, the diameter of the main body is 150 to 250 mm.

In the gas hydrate fire extinguishing grenade according to the present invention, the detection member is a heat detection sensor that detects the temperature around the main body, and two or more heat detection sensors are provided on the main body.

In the gas hydrate fire extinguishing grenade according to the present invention, the transmission member is composed of a heat transfer wire, and the heat transfer wire is connected between the heat detection sensor and the expansion agent.

In the gas hydrate fire extinguishing grenade according to the present invention, the expansion agent is ignited at 300° C. or above.

In the gas hydrate fire extinguishing grenade according to the present invention, the diameter of the main body is 60 to 80 mm.

In order to achieve the above objects, the method of extinguishing flames according to the present invention includes (a) mounting a gas hydrate fire extinguishing grenade on an aerial vehicle capable of moving in the sky, wherein the gas hydrate fire extinguishing grenade includes a ball-shaped main body composed of non-flammable plastic, a gas hydrate member filled in the main body, an expansion agent provided in the central part of the main body, a weight member composed of a different material from the main body and provided at the lower central part of the main body, an impact sensor and a piezoelectric element provided at the weight member, and an ignition wire connected between the piezoelectric element and the expansion agent, (b) free falling the fire extinguishing grenade from the aerial vehicle toward the flames, with the weight member located at the lower central part of the main body, and igniting the piezoelectric element when free falling from the aerial vehicle at an altitude of 10 m or more, (c) expanding the expansion agent by the ignition in step (b), and (d) shattering the main body by the expansion of the expansion agent in step (c) and spraying the gas hydrate member onto the flames.

In order to achieve the above objects, the method of extinguishing flames according to the present invention extinguishes flames by throwing a gas hydrate fire extinguishing grenade that includes a ball-shaped main body composed of non-flammable plastic, a gas hydrate member filled in the main body, an expansion agent provided in the central part of the main body, two or more heat detection sensors provided on the main body to detect the temperature around the main body, and a heat transfer wire connected between the heat detection sensor and the expansion agent, and the method includes (a) throwing the fire extinguishing grenade around the flames, (b) detecting the temperature around the flames by the heat detection sensors and expanding the expansion agent when the temperature is detected to be 300° C. or above, and (c) shattering the main body by the expansion of the expansion agent in step (b) and spraying the gas hydrate member onto the flames.

In the method of extinguishing flames according to the present invention, the throwing is performed by a launcher.

### Advantageous Effects

As described above, the gas hydrate fire extinguishing grenade and the method of extinguishing flames using the same according to the present invention can have a remarkable combustion blocking function (efficient combustion suppression) due to its wide fire suppression range per unit volume; a physical property of absorbing surrounding heat (cooling effect); and an excellent effect for initial throwing suppression (remote throwing) due to the high-density filling of the fire extinguishing gas (density of about 0.95) that prevents it from being pushed away by flames.

In addition, the gas hydrate fire extinguishing grenade and the method of extinguishing flames using the same according to the present invention have various advantages, such as an oxygen blocking function, a cooling effect, inhibition of a flame chain reaction, a wide fire suppression range, a physical property of rapidly absorbing heat from the surroundings, and a remote throwing function, making them applicable to various types of fires.

### DESCRIPTION OF DRAWINGS

FIG. 1 is an explanatory diagram of the structure of the gas hydrate used in the present invention.

FIG. 2 is a configuration diagram of a gas hydrate fire extinguishing grenade according to a first embodiment of the present invention.

FIG. 3 is a process diagram of flame extinguishing using the fire extinguishing grenade shown in FIG. 2.

FIG. 4 is a configuration diagram of a gas hydrate fire extinguishing grenade according to a second embodiment of the present invention.

FIG. 5 is a process diagram of flame extinguishing using the fire extinguishing grenade shown in FIG. 4.

FIG. 6 is a configuration diagram illustrating an example of a launcher used in the throwing process shown in FIG. 5.

### MODES OF THE INVENTION

The above and other objects and new features of the present invention will become clearer by the description of this specification and the attached drawings.

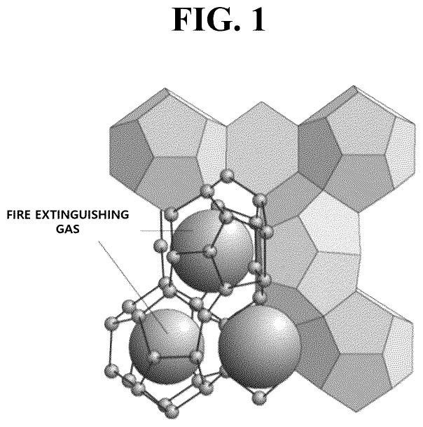

As shown in FIG. 1, the term “gas hydrate” used herein refers to a state in which a fire extinguishing gas and water (a fire extinguishing solvent) are physically combined, and in this state, more than 50 times more fire extinguishing gas may be stored within the lattice structure of water. FIG. 1 is an explanatory diagram of the structure of the gas hydrate used in the present invention.

Since the hydrate can quickly extinguish fires by generating a large amount of fire extinguishing gas and releasing water when a fire occurs, this crystalline fire extinguishing grenade has a wide fire suppression range per unit volume and may be thrown from long distances, making it effectively applicable to various types of industrial fire suppression (Class A, B, and C fires).

In other words, the gas hydrate used in the present invention is composed of water or a polar solvent, which is capable of hydrogen bonding and is a non-flammable solvent, called the host, and a gas called the guest, and is present stably in a solid state at an appropriate pressure and temperature. The solvent may be one or more selected from the group consisting of water, phenol, and ketone, and the gas may be one or more types selected from the group consisting of carbon dioxide, nitrogen gas, SF₆ gas, HFC series gases, Halon series gases, other fire prevention gases, and clean fire extinguishing agents, which are gases with excellent insulation and combustion blocking functions.

Table 1 below shows the types of fire extinguishing gases that do not harm the global environment according to the “Fire Safety Standards for Halogenated Compounds and Inert Gas Fire Extinguishing Systems” issued by the National Fire Agency in 2018, which presents basic physical property analysis data for the application of four types of gas hydrate fire extinguishing grenades: CO₂, HFC-125, HFC-23, and FIC-1311. Therefore, in the present invention, HFC-125, HFC-23, FIC-1311, etc. may be applied as fire extinguishing gas.

TABLE 1

| | | | | | | | | Gas |
|---|---|---|---|---|---|---|---|---|
| | | | | Flame | | | | storage |
| | | | | extinguishing | | | Enthalpy²⁾ | rate per |
| | Chemical | | | concentration | | | (KJ/Kg- | unit |
| Classification | Name | Formula | Structure | (vol %)¹⁾ | ODP | GWP | Hydrate) | volume³⁾ |
| Halon gas (currently prohibited) | Halon- 1301 | CF₃Br | 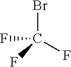 | 3.1 | 10.0 | 5000 | — | — |
| Halogen gas fire extinguishing agent (available) | Carbon dioxide HFC-125 | CO₂ CHF₂CF₃ | O═C═O 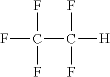 | 19.6 8.4 | 0.0 0.0 | 1 3500 | 374 254 | 146 times 51 times |
| | HFC- 227ea | CF₃CHFCF₃ | 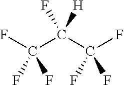 | 6.1 | 0.0 | 3220 | — | No gas hydrate formation |
| | HFC-23 | CHF₃ | 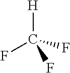 | 11.8 | 0.0 | 14800 | 503 | 125 times |
| | FIC-1311 | CF₃I | 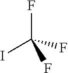 | 2.9 | 0.0001 | 0.4 | −300 | 72 times |

In Table 1, 1) flame extinguishing concentration measures the concentration of fire extinguishing agent needed to extinguish flames, and lower values indicate better extinguishing performance, 2) enthalpy represents the amount of heat absorbed per unit weight during gas hydrate dissociation, and 3) gas storage rate per unit volume of gas hydrate is given under standard temperature and pressure (STP) conditions.

The gas hydrate may be formed in multiple combinations of host-guest groups. For example, it is preferable to have a composition of (one or multiple host substances)-(one or multiple guest substances). In addition, the gas hydrate may be produced by further including additives as needed.

Hereinafter, embodiments of the present invention will be described with reference to the drawings.

### FIRST EMBODIMENT

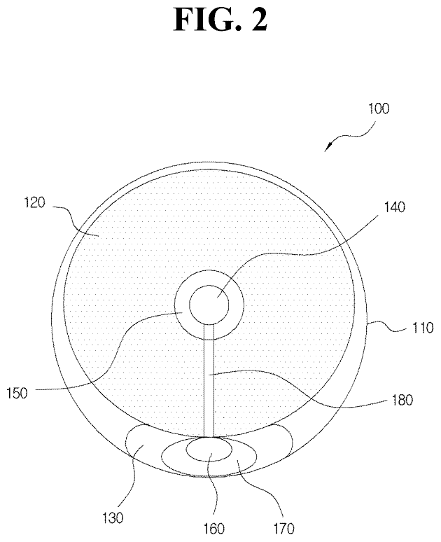

FIG. 2 is a configuration diagram of a gas hydrate fire extinguishing grenade according to a first embodiment of the present invention. The fire extinguishing grenade according to the first embodiment of the present invention may be mounted, for example, on an aerial vehicle such as a drone or a helicopter capable of moving in the sky, and may be designed to extinguish flames by free fall.

As shown in FIG. 2, a gas hydrate fire extinguishing grenade 100 according to the first embodiment of the present invention is a gas hydrate fire extinguishing grenade for extinguishing flames and preventing the spread of fire and may include a roughly ball-shaped main body 110, a gas hydrate member 120 filled in the main body 110, a weight member 130 composed of a different material from the main body 110 and provided at the lower central part of the main body 110, a detection member provided on the outer side of the main body 110, an expansion agent 140 provided at approximately the central part of the main body 110, a hydrate breaker 150 provided to surround the expansion agent 140, a transmission member that transmits the impact sensitivity detected from the detection member to the expansion agent 140, and an igniter 170 that operates the expansion agent.

The main body 110 may be composed of non-flammable plastic which is a relatively light plastic material that reduces the overall weight of the fire extinguishing grenade 100 and may be easily crushed by the expansion of the expansion agent 140, but is not limited to this, and may also be composed of a flame-retardant vinyl material. The main body 110 may be prepared as a single piece using conventional injection molding techniques with the part (opening), in which the weight member 130 is combined, left open. In addition, in the above description, the main body 110 is described as having a spherical shape, but is not limited thereto and may have a polygonal shape.

The gas hydrate member 120 is composed of, for example, pure water, HFC-125, HFC-23, and FIC-1311 in the form of powder or pellets, and may be filled in the main body 110 through the opening in which the weight member 130 is combined.

The weight member 130 may be designed to be approximately circular and composed of a material heavier than the main body 110 so that the detection member is located at the lower central part of the main body 110 to detect the impact upon falling when the fire extinguishing grenade 100 is in free fall from a movable aerial vehicle. In other words, the weight member 130 is provided in a size corresponding to the above-described opening and may be composed of a metal material that is heavier than plastic or a ceramic material that may be easily damaged due to the contact with the ground when the fire extinguishing grenade 100 is in free fall.

The expansion agent 140 may include sodium azide or guanidine nitrate.

The sodium azide has the chemical formula: NaN₃ (Sodium trinitride, Smite, Azium), melting point: 275 [° C.], flash point: 300 [C], molar mass: 65.0 [g/mol], color: colorless to white, and odor: odorless. The guanidine nitrate has the chemical formula: [C(NH₂)₃]NO₃ or CH₆N₄O₃, which is a compound of nitric acid (HNO₃) and guanidine (C(NH)(NH₂)₂, melting point: 216 [C], density: 1.44 [g/cm³], molar mass: 122.0833 [g/mol], and appearance: white, water-soluble crystalline powder, and is decomposed at 250° C. or above. The guanidine nitrate can ignite when mixed with combustible materials, and explodes when heated and is used in fireworks, gas generators, manufacture of explosives, and rocket propellant fuel, and it is possible to use guanidine nitrate as a substitute for sodium azide in airbags to overcome sodium azide's weakness to moisture.

The sodium azide is a chemically stable substance, but violently reacts with iron oxide (Fe₂O₃) and generates nitrogen in a very short time (0.03-0.05 seconds) as described below.

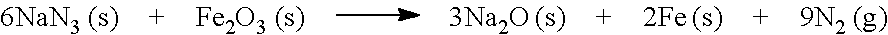

In addition, the sodium azide is decomposed by spark ignition, generating a large amount of nitrogen gas.

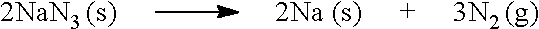

This chemical reaction is applied, for example, to automobile airbags, and in the present invention, this technology is adapted for use as an expansion agent in the gas hydrate fire extinguishing grenade 100.

The hydrate breaker 150 is composed of, for example, sand and is provided to crush the main body 110 by applying pressure to the gas hydrate member 120 when the expansion agent 140 expands. The expansion agent 140 is formed in a roughly spherical shape corresponding to the main body 110, and the hydrate breaker 150 has a circular shape that surrounds the entire expansion agent 140 and is inserted into the approximately center of the main body 110 through the opening.

The detection member is provided as an impact sensor 160 that detects the impact sensitivity of the fire extinguishing grenade 100 according to the first embodiment of the present invention when it is in free fall.

The impact sensor 160 is set to a sensitivity based on a specific height. For example, the velocity of the fire extinguishing grenade when it is in free fall from an altitude of about 10 m or more from an aerial vehicle is given by the following Equation 1.

$$Equation 1$$

$$v = sqrt ( 2 gh ) = sqrt ( 2 \times 9.8 \times 10. ) \approx 14. [ m / s ] \approx 50.4 [ km / h ]$$

In this case, the falling speed is about 50 [km/h], and when the weight of the fire extinguishing grenade is about 500 [g], the impact force is given by the following Equation 2.

$$Equation 2$$

$$Ft = ( m \times Δ v ) / Δ t = m \times ( v 2 - v 1 ) / Δ t = 0.5 \times ( 50 - 0 ) / 0.1 = 250 [ N ] = 0.25 [ kN ]$$

Thus, the impact sensor 160 may be set to operate at an impact force of 0.25 [kN] or more. For example, when dropped from a height of 20 [m] above the ground, the velocity (v) would be approximately 19.8 m/s or 71.3 km/h (v=19.8 [m/s]=71.3 [km/h]), and in this case, the impact force (Ft) would be about 356.5 N or 0.357 kN, calculated as Ft=0.5×(71.3-0)/0.1=356.5 [N]=0.357 [kN].

Therefore, the igniter 170 may be designed to ignite when the impact sensor 160 detects an impact sensitivity corresponding to a free fall from an altitude of about 10 [m] or more, that is, at a speed of about 50 [km/h] or more.

Therefore, the igniter 170 does not require a separate power supply and may use a highly reliable piezoelectric element. The piezoelectric element, also called a piezo element, is a component of a control system using a material (PZT lead zirconate titanate) that exhibits a piezoelectric effect, and is provided to generate a spark using the electricity induced when a pressure of 0.25 [kN] is applied upward by the impact sensor 160. That is, in the first embodiment of the present invention, by applying a piezoelectric element as the igniter 170 in the gas hydrate fire extinguishing grenade 100, the piezoelectric element is activated by an impact force of 0.25 [kN] or more, and the electricity induced at this time generates a spark that operates the expansion agent 140. In addition, it is preferable to design the piezoelectric element to operate even at a downward 45° inclination.

As shown in FIG. 2, the above-described impact sensor 160 and piezoelectric element 170 are provided in the central part of the weight member 130 to detect the impact at the lower central part of the fire extinguishing grenade 100 according to the first embodiment of the present invention during free fall and ignite accordingly.

The transmission member is composed of an ignition wire 180 connected between the igniter 170 and the expansion agent 140, and is provided to transmit the electricity induced in the igniter 170 to the expansion agent 140.

The diameter of the fire extinguishing grenade 100 according to the first embodiment, as described above, may be, for example, 150 to 250 mm, preferably about 200 mm, so as to have an effective fire extinguishing area with a radius of 3 m or more, and its weight may be about 500 to 800 g.

In other words, the fire extinguishing grenade 100 according to the first embodiment of the present invention is mainly used for dropping from an aerial vehicle such as a drone or a helicopter, and a plurality of grenades may be mounted on a firefighting drone with a maximum payload of 30 kg.

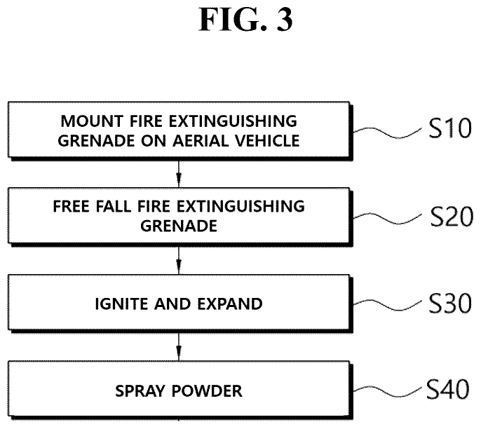

Hereinafter, the process of extinguishing flames using the fire extinguishing grenade 100 according to the first embodiment of the present invention will be explained with reference to FIG. 3.

FIG. 3 is a process diagram of flame extinguishing using the fire extinguishing grenade shown in FIG. 2.

First, the gas hydrate fire extinguishing grenade 100, which includes a ball-shaped main body composed of non-flammable plastic, gas hydrate powder or pellets filled in the main body, an expansion agent provided in the central part of the main body, a weight member composed of a different material from the main body and provided at the lower central part of the main body, an impact sensor and a piezoelectric element provided at the weight member, and an ignition wire connected between the piezoelectric element and the expansion agent, is mounted on an aerial vehicle capable of moving in the sky (S10).

When the fire extinguishing grenade 100 is in free fall from the aerial vehicle toward the flames (S20), the weight member is located at the lower central part of the main body, the piezoelectric element is ignited when free-falling from the aerial vehicle at an altitude of 10 m or more, and the expansion agent is expanded by the ignition (S30).

As the main body is shattered by the expansion of the expansion agent in S30, the gas hydrate member may be sprayed onto the flames to extinguish the flames (S40).

Thus, when applying the fire extinguishing grenade 100 according to the first embodiment of the present invention to suppress forest fires, it is possible to directly extinguish fires by dropping impact sensor-type fire extinguishing grenades 100 from drones in front of the advancing direction of open fires such as forest fires, and since the weight of each fire extinguishing grenade 100 is set to about 500 to 800 g in consideration of the maximum payload of drones (up to 30 kg), it is possible to drop a plurality of fire extinguishing grenades 100 during a single flight of the aerial vehicle.

In addition, since the function of the gas hydrate fire extinguishing grenade of the present invention may be integrated with various capabilities of existing developed swarm drones (such as thermal imaging analysis and AI autonomous mission execution), it is possible to suppress fires at night and monitor and extinguish embers. Additionally, when suppressing high-rise building fires, drones may be used to throw gas hydrate fire extinguishing grenades 100 onto rooftops or balconies of high-rise buildings, minimizing casualties and damage.

### SECOND EMBODIMENT

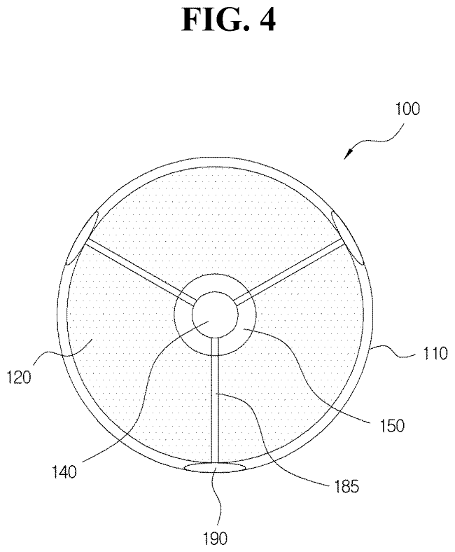

FIG. 4 is a configuration diagram of a gas hydrate fire extinguishing grenade according to a second embodiment of the present invention. The fire extinguishing grenade according to the second embodiment of the present invention may extinguish flames by being directly thrown by a user such as a firefighter or by being thrown after being mounted on a dedicated launcher. In the second embodiment, the same reference numerals are given to parts identical to those in the first embodiment, and redundant descriptions are omitted.

As shown in FIG. 4, a gas hydrate fire extinguishing grenade 100 according to the second embodiment of the present invention is a gas hydrate fire extinguishing grenade for extinguishing flames and preventing the spread of fire and may include a roughly ball-shaped main body 110, a gas hydrate member 120 filled in the main body 110, a plurality of detection members provided on the outer side of the main body 110, an expansion agent 140 provided at approximately the central part of the main body 110, a hydrate breaker 150 provided to surround the expansion agent 140, and a transmission member that transmits the temperature detected from the plurality of detection members to the expansion agent 140.

The main body 110 may be composed of non-flammable plastic which is a relatively light plastic material that reduces the overall weight of the fire extinguishing grenade 100 and may be easily crushed by the expansion of the expansion agent 140, and the main body 110 may have a diameter of 60 to 80 mm, preferably 70 mm, so that users may throw the grenade directly or mount it on a dedicated launcher before it is thrown.

For example, the gas hydrate member 120 is composed of pure water, HFC-125, HFC-23, and FIC-1311 in the form of powder or pellets, and may be filled in the main body 110 through the opening in which the detection member is combined. The expansion agent 140 may include sodium azide or guanidine nitrate. The hydrate breaker 150 is composed of, for example, sand and is provided to crush the main body 110 by applying pressure to the gas hydrate member 120 when the expansion agent 140 expands.

The transmission member is composed of heat transfer wires 185, and the heat transfer wires 185 are connected between heat detection sensors 190, which are a plurality of detection members, and the expansion agent 140.

Two or more heat detection sensors 190 may be provided on the main body 110 to detect the temperature around the main body 110. In other words, FIG. 4 shows a structure in which three heat detection sensors 190 are provided at intervals of 120 degrees, but the structure is not limited thereto, and four or more heat detection sensors 190 may be provided. In addition, the heat detection sensor 190 may be designed to ignite when heat from the fire site is conducted and the temperature becomes about 300° C. or above.

The diameter of the fire extinguishing grenade 100 according to the second embodiment, as described above, may be, for example, 60 to 80 mm, preferably about 70 mm, so as to have an effective fire extinguishing area with a radius of 1 m or more, and its weight may be about 50 to 60 g.

Since the fire extinguishing grenade 100 according to the second embodiment of the present invention is thrown directly by a user such as a firefighter or is thrown after being mounted on a dedicated launcher, etc., it may have a smaller size than the first embodiment of the present invention.

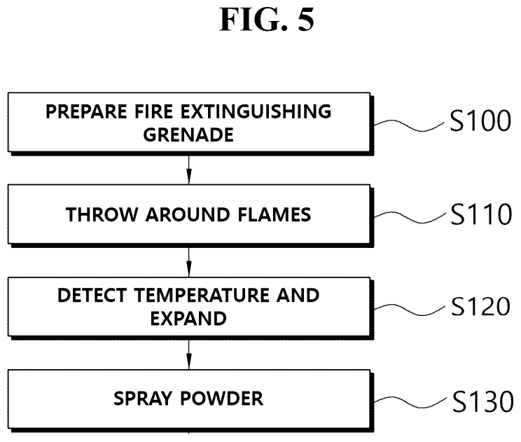

Hereinafter, the process of extinguishing flames using the fire extinguishing grenade 100 according to the second embodiment of the present invention will be explained with reference to FIG. 5.

FIG. 5 is a process diagram of flame extinguishing using the fire extinguishing grenade shown in FIG. 4.

First, a gas hydrate fire extinguishing grenade 100, which includes a ball-shaped main body composed of non-flammable plastic, a gas hydrate member filled in the main body, an expansion agent provided in the central part of the main body, two or more heat detection sensors provided on the main body to detect the temperature around the main body, and a heat transfer wire connected between the heat detection sensor and the expansion agent, is prepared (S100).

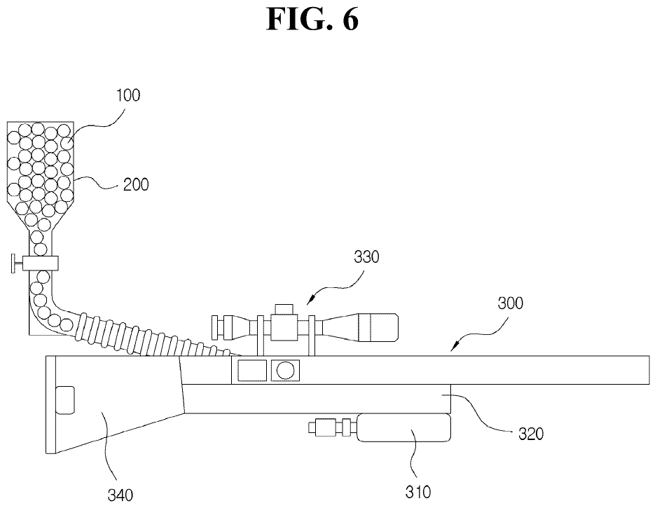

The fire extinguishing grenade 100 prepared in S100 may be thrown directly by a user such as a firefighter or may be thrown around the flames after being mounted on a dedicated launcher 300 that may be used as a personal portable device and a vehicle-mounted or helicopter-mounted device, as shown in FIG. 6 (S110).

FIG. 6 is a configuration diagram illustrating an example of a launcher 300 used in the throwing process shown in FIG. 5, and may be composed of a barrel combined with a fire extinguishing grenade feeder 200 that supplies fire extinguishing grenades 100, an extrusion air charging connector 310, a compressed air cylinder 320, a sight 330, and a body 340.

The heat detection sensor in the fire extinguishing grenade of the second embodiment, which is thrown in S110, detects the temperature around the flames, and when it detects a temperature of 300° C. or above, the expansion agent expands (S120).

As the main body is shattered by the expansion of the expansion agent in S120, the gas hydrate member may be sprayed onto the flames to extinguish the flames (S130).

Thus, when applying the fire extinguishing grenade 100 according to the second embodiment of the present invention to suppress forest fires, heat detecting fire extinguishing grenades may be intensively dropped in a belt-like pattern at regular intervals and widths ahead of the advancing direction of the fire to prevent the fire from spreading further.

For example, it is possible to establish multiple defense lines such as primary and secondary lines with varying densities of fire extinguishing grenades on each line, thereby efficiently protecting historical sites or major industrial facilities and preventing the spread of embers. In addition, as a fire extinguishing method when a space for deployment is available, the heat-detecting fire extinguishing grenade 100 according to the second embodiment of the present invention and a launching device may be mounted on drones to be thrown into horizontally open spaces of high-rise buildings or thrown into buildings using impact sensors depending on fire characteristics.

Additionally, as a method to deal with intense flames in industrial complexes, the fire extinguishing grenade 100 of the second embodiment of the present invention, which is capable of remote throwing of 100 to 200 m, may be applied to intense flames occurring in LNG infrastructure and chemical plant complexes because these areas are typically only manageable with powder fire extinguishing agents (sprayed within 30 m) and high-expansion foam (fixed installation), and for battery fires in electric vehicles or the energy storage system (ESS), it is possible to dramatically control the thermal runaway caused by battery fires by applying the fire extinguishing grenade 100 of the second embodiment of the present invention around the fires because the gas hydrate fire extinguishing agent has a physical property of rapidly absorbing heat from the surroundings, and water and the fire extinguishing gas are released in the flames.

### INDUSTRIAL APPLICABILITY

The gas hydrate fire extinguishing grenade and the method of extinguishing flames using the same according to the present invention provide various advantages, such as an oxygen blocking function, a cooling effect, inhibition of a flame chain reaction, a wide fire suppression range, a physical property of rapidly absorbing heat from the surroundings, and a remote throwing function, making them applicable to various types of fires.

1. A gas hydrate fire extinguishing grenade for extinguishing flames and preventing the spread of fire, comprising:
a main body;
a gas hydrate member filled in the main body;
a detection member provided on the outer side of the main body;
an expansion agent provided in the central part of the main body; and
a transmission member that transmits the impact sensitivity or the temperature detected from the detection member to the expansion agent.

2. The grenade of claim 1, further comprising a hydrate breaker provided to surround the expansion agent.

3. The grenade of claim 2, wherein the main body is composed of non-flammable plastic, and the expansion agent includes sodium azide or guanidine nitrate.

4. The grenade of claim 3, wherein the gas hydrate member is provided in the form of powder or pellets.

5. The grenade of claim 4, wherein the fire extinguishing gas of the gas hydrate member is composed of any one of CO₂, HFC-125, HFC-23, and FIC-1311 or a mixture thereof.

6. The grenade of claim 4, further comprising an igniter that operates the expansion agent, wherein the transmission member is composed of an ignition wire, and the ignition wire is connected between the igniter and the expansion agent.

7. The grenade of claim 6, wherein the detection member is an impact sensor that detects impact sensitivity during free fall, and the igniter is a piezoelectric element that operates according to the impact sensitivity detected by the impact sensor.

8. The grenade of claim 7, wherein a weight member composed of a different material from the main body is provided at the lower central part of the main body, and the impact sensor and the piezoelectric element are provided at the weight member.

9. The grenade of claim 8, wherein the piezoelectric element is ignited when free falling from an altitude of 10 m or more.

10. The grenade of claim 8, wherein the diameter of the main body is 150 to 250 mm.

11. The grenade of claim 4, wherein the detection member is a heat detection sensor that detects the temperature around the main body, and two or more heat detection sensors are provided on the main body.

12. The grenade of claim 11, wherein the transmission member is composed of a heat transfer wire, and the heat transfer wire is connected between the heat detection sensor and the expansion agent.

13. The grenade of claim 12, wherein the expansion agent is ignited at 300° C. or above.

14. The grenade of claim 12, wherein the diameter of the main body is 60 to 80 mm.

15. A method of extinguishing flames, the method comprising:
(a) mounting a gas hydrate fire extinguishing grenade on an aerial vehicle capable of moving in the sky, wherein the gas hydrate fire extinguishing grenade includes a ball-shaped main body composed of non-flammable plastic, a gas hydrate member filled in the main body, an expansion agent provided in the central part of the main body, a weight member composed of a different material from the main body and provided at the lower central part of the main body, an impact sensor and a piezoelectric element provided at the weight member, and an ignition wire connected between the piezoelectric element and the expansion agent;
(b) free falling the fire extinguishing grenade from the aerial vehicle toward the flames, with the weight member located at the lower central part of the main body, and igniting the piezoelectric element when free falling from the aerial vehicle at an altitude of 10 m or more;
(c) expanding the expansion agent by the ignition in step (b); and
(d) shattering the main body by the expansion of the expansion agent in step (c) and spraying the gas hydrate member onto the flames.

16. A method of extinguishing flames by throwing a gas hydrate fire extinguishing grenade that includes a ball-shaped main body composed of non-flammable plastic, a gas hydrate member filled in the main body, an expansion agent provided in the central part of the main body, two or more heat detection sensors provided on the main body to detect the temperature around the main body, and a heat transfer wire connected between the heat detection sensor and the expansion agent, the method comprising:
(a) throwing the fire extinguishing grenade around the flames;
(b) detecting the temperature around the flames by the heat detection sensors and expanding the expansion agent when the temperature is detected to be 300° C. or above; and
(c) shattering the main body by the expansion of the expansion agent in step (b) and spraying the gas hydrate member onto the flames.

17. The method of claim 16, wherein the throwing is performed by a launcher.
